(19) United States
(12) Patent Application Publication
(10) Pub. No.: US 2004/0011167 A1
(43) Pub. Date: Jan. 22, 2004

(54) Structure for processing a terminal of a flat cable

(75) Inventor: Takeya Miwa, Shizuoka (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/053,007

(22) Filed: Jan. 23, 2002

(30) Foreign Application Priority Data
Jan. 24, 2001 (JP) P2001-016005

(51) Int. Cl. B26D 1/04

(52) U.S. Cl. 83/13; 83/620

(57) ABSTRACT

A flat cable (13) is formed by a plurality of juxtaposed conductors (15) which are insulated and coated. An end portion of the flat cable (13) is provided with a terminal processing structure in which cut surfaces (15a, 15b) of the respective conductors (15) are alternately positioned in a staggered manner, thereby making it possible to lengthen the creeping distance between the cut surfaces of the adjacent conductors.

### BACKGROUND OF THE INVENTION

The present invention relates to a structure for processing a terminal of a flat cable, and more particularly to the prevention of leaks between conductors at a terminal of a flat cable in which a plurality of the juxtaposed conductors are sheathed and insulated.

Generally, in a case where a circuit member is formed by connecting, to electric equipment and the like, a flat cable in which a plurality of juxtaposed conductors are sheathed and insulated, the elongated flat cable is generally used after being cut to a desired length.

As shown in FIG. 4, when a flat cable 53 is connected to electric equipment and the like, a terminal connector 6 attached to an end of the flat cable 53 is generally used.

As shown in FIGS. 4 and 5, the terminal connector 6 has a connector body 61 and a pair of holding members 62 and 63 capable of clamping the flat cable 53 over its entire width.

As shown in FIG. 5, as conductors 55 at the end of the flat cable 53 are subjected to insulation displacement connection to insulation displacing blades 64 of respective connecting terminals accommodated in respective terminal accommodating chambers of the connector body 61 and projecting from a rear end face of the connector body 61, the conductors 55 of the flat cable 53 including the insulating coatings can be separated along the longitudinal direction over an appropriate length, or the conductors 55 can be electrically connected easily to the respective connecting terminals with the insulating coatings displaced but without exposing the conductors 55.

Furthermore, in a state in which a portion of the flat cable 53 located away from the connector body 61 by an appropriate distance is clamped by the holding members 62 and 63, the flat cable 53 is turned back at a position substantially intermediate between the connector body 61 and the holding members 62 and 63, as shown in FIG. 4, and the holding members 62 and 63 are connected to a rear end portion of the connector body 61. Thus an arrangement is provided such that even if a tensile force has been applied to the flat cable 53, a load is not applied to insulation-displaced portions displaced by the insulation displacing blades 64.

However, as shown in FIG. 4, since cut surfaces of the conductors 55 are exposed at an end face of the conventional flat cable 53 which has been cut straightly in the widthwise direction, and the distance between adjacent ones of the conductors 55 is short, there has been a problem in that the occurrence of a leakage current is likely to result.

In addition, although a terminal processing structure is conceivable in which the cut surfaces of the conductors 55 are covered by, for example, sheathing the end face of the flat cable 53 with an insulating resin or sheathing its end portion with an insulating cap, there is a problem in that the number of steps of operation increases, resulting in increased cost.

Further, in a case where the conductors 55 of the flat cable 53 including the insulating coatings are separated along the longitudinal direction over an appropriate length, and the conductors 55 which have been thus formed in single coated wires are subjected to insulation displacement connection to the insulation displacing blades 64 of the connecting terminals juxtaposed with gaps widened therebetween, the connection operation becomes complex, and the connector body 61 disadvantageously becomes large in size.

### SUMMARY OF THE INVENTION

Accordingly, the object of the invention is to provide an inexpensive structure for processing a terminal of a flat cable in which a plurality of juxtaposed conductors are insulated and coated and which makes it possible to prevent the occurrence of a leakage current between the conductors at an end portion of the flat cable, thereby overcoming the above-described problems.

In order to solve the aforesaid object, the invention is characterized by having the following arrangement.

(1) A structure for processing an end portion of a flat cable in which a plurality of juxtaposed conductors are sheathed and insulated, respectively, wherein the end portion of the flat cable is cut in a stepped form so that cut surfaces of at least adjacent ones of the conductors are positioned in different planes.

(2) The structure according to (1), wherein the end portion of the flat cable is cut in the stepped form so that the cut surfaces of the conductors are alternately positioned in a staggered manner.

(3) A method of processing an end portion of a flat cable in which a plurality of juxtaposed conductors are sheathed and insulated, respectively, the method comprising the step of:

cutting the end portion of the flat cable in a stepped form so that cut surfaces of at least adjacent ones of the conductors are positioned in different planes.

(4) The method according to (3), wherein the end portion of the flat cable is cut in the stepped form so that the cut surfaces of the conductors are alternately positioned in a staggered manner.

(5) The method according to (4), wherein the flat cable is collectively cut along a widthwise direction of the flat cable by using a cutter blade having a blade shape in which rectangular sections continue in a zigzag manner.

In accordance with the above-described construction, since the creeping distance between the cut surfaces of adjacent ones of the conductors becomes long by cutting the end portion of the flat cable in the stepped form such that the cut surfaces of the conductors are positioned in different planes, it becomes difficult for a leakage current to flow between the conductors.

### BRIEF DESCRIPTION OF THE DRAWINGS

FIG. 1 is an overall perspective view of an terminal connector to which the structure for processing a terminal of a flat cable in accordance with an embodiment of the invention is applied;

FIG. 2 is an exploded perspective view of the terminal connector shown in FIG. 1;

FIG. 3 is a cross-sectional view of the terminal connector shown in FIG. 1;

FIG. 4 is an overall perspective view of the terminal connector to which a conventional structure for processing a terminal of a flat cable is applied;

FIG. 5 is an exploded perspective view of the terminal connector shown in FIG. 1.

### DETAILED DESCRIPTION OF PREFERRED EMBODIMENTS

Referring now to the accompanying drawings, a detailed description will be given of the structure for processing a terminal of a flat cable in accordance with an embodiment of the invention.

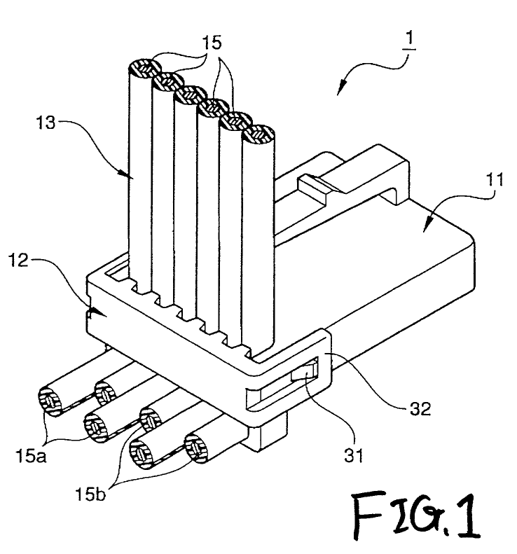

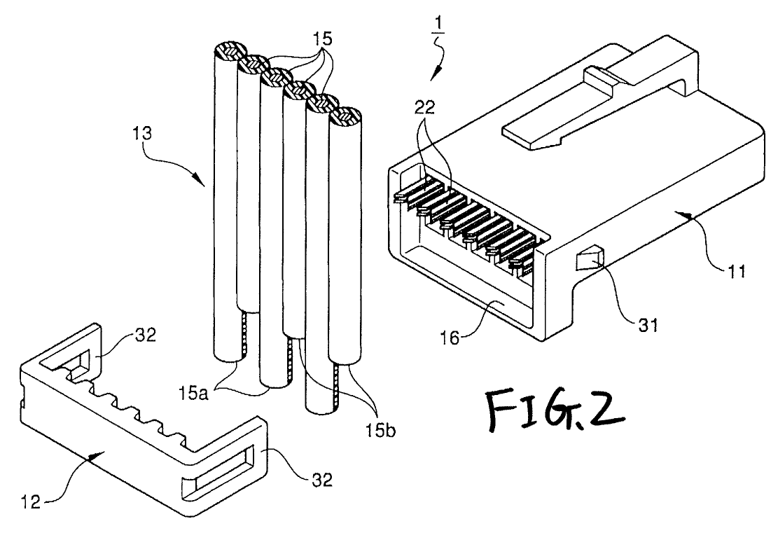

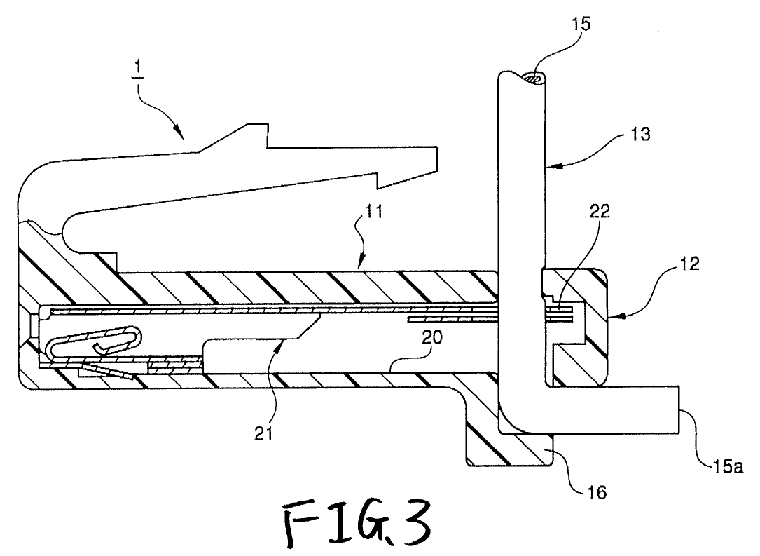

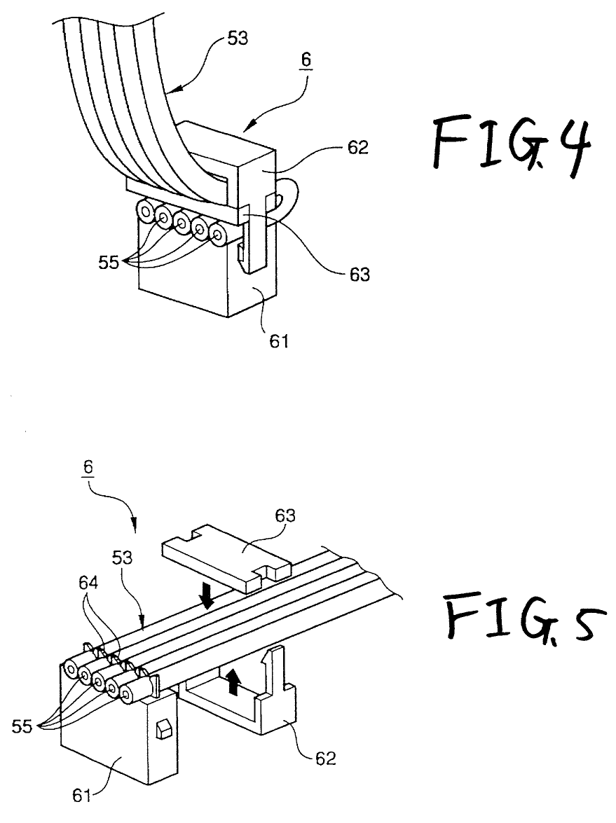

FIG. 1 is an overall perspective view of a terminal connector to which the structure for processing a terminal of a flat cable in accordance with an embodiment of the invention is applied. FIG. 2 is an exploded perspective view of the terminal connector shown in FIG. 1. FIG. 3 is a cross-sectional view of the terminal connector shown in FIG. 1.

A terminal connector 1 shown in FIG. 1 is a flat cable connector which is attached to an end portion of a flat cable 13, and is constituted by a connector body 11 for accommodating a plurality of connecting terminals 21 and a holding member 12 for covering a rear end face of the connector body 11.

As shown in FIGS. 2 and 3, the connector body 11 is integrally formed of an insulating resin material substantially in the form of a rectangular parallelepiped, and an end portion of a flat cable 13 is subjected to insulation displacement connection to insulation displacing blades 22 of the respective connecting terminals 21 which is accommodated in respective terminal accommodating chambers 20 and project from a rear end face (a right-hand face in FIG. 3) of the connector body 11 in such a manner as to be arranged in a row.

As shown in FIG. 2, the flat cable 13 in this embodiment is a so-called ribbon cable in which a plurality of juxtaposed conductors 15 are sheathed and insulated. In this embodiment, the end portion (a lower end portion in FIG. 2) of the flat cable 13 has a terminal processing structure in which the end portion of the flat cable 13 is cut in a stepped form such that cut surfaces 15a and 15b of the conductors 15 are alternately positioned in a staggered manner.

The conductors 15 are subjected to insulation displacement connection to the insulation displacing blades 22 in such a manner that the conductors 15 respectively correspond to the insulation displacing blades 22 of the connector terminal, and a portion of the flat cable 13 located away from its tip by an appropriate distance is pressed against the rear end face of the connector body.

Next, the holding member 12 is fitted to the rear end face of the connector body 11 in such a manner as to clamp the end portion of the flat cable 13 between the holding member 12 and the rear end face of the connector body 11 in the widthwise direction. A pair of lock arms 32, which are respectively retained by a pair of retaining projections 31 provided projecting on both side surfaces of the connector body 11, extend from both ends of the holding member 12, so that the holding member 12 is reliably fitted to the connector body 11.

Further, a cable bending portion 16 extending in a direction perpendicular to the rear end face of the connector body 11 is provided in such a manner as to project from a lower edge of the rear end face of the connector body 11. Accordingly, as shown in FIG. 3, the end portion of the flat cable 13 pressed against the rear end face of the connector body 11 by the holding member 12 is held and fixed in a state in which its tip portion is bent substantially orthogonal by the cable bending portion 16, so that even if a tensile force is applied to the flat cable 13, no load is applied to insulation displaced portions displaced by the insulation displacing blades 22.

Namely, according to the structure for processing the terminal of the flat cable 13 in this embodiment, since the end portion of the flat cable 13 is cut in a stepped form such that the cut surfaces 15a and 15b of the conductors 15 are alternately positioned in a staggered manner, the creeping distance between the cut surfaces of adjacent ones of the conductors 15 becomes long. Therefore, it becomes difficult for a leakage current to flow between the adjacent conductors 15.

Accordingly, it becomes unnecessary to cover the cut surfaces of the conductors 15 by, for example, coating the end face of the flat cable 13 with an insulating resin or covering the end portion thereof with an insulating cap, thereby making it possible to prevent the cost from rising due to the increase in the number of steps of operation and the number of component parts.

To cut the end portion of the flat cable 13 in the stepped form such as the one shown in FIG. 2, the elongated flat cable 13 can be collectively cut along the widthwise direction by using a cutter blade having a blade shape in which rectangular sections continue in a zigzag manner, so that the cutting process does not become complex.

It should be noted that the structure for processing a terminal of a flat cable in accordance with the invention is not limited to the structure for processing the terminal of the flat cable 13 in the above-described embodiment, and it goes without saying that it is possible to adopt various forms based on the gist of the invention.

For example, although in the above-described embodiment the end portion of the flat cable 13 is cut in a stepped form such that the cut surfaces 15a and 15b of the conductors 15 are alternately positioned in a staggered manner, the invention is not limited to this shape. In addition, although the ribbon cable is used as the flat cable in the above-described embodiment, the invention may be applied to other flat cables such as a flexible flat cable (FFC).

Accordingly, it suffices if the end portion of the flat cable 13 is cut in a stepped form such that the cut surfaces 15a and 15b of at least adjacent ones of the conductors 15 are positioned in different planes, and the end portion of the flat cable 13 can be cut into various shapes in accordance with the gist of the invention.

However, by cutting the end portion of the flat cable 13 in a stepped form such that the cut surfaces 15a and 15b of the conductors 15 are alternately positioned in a staggered manner as in the structure for processing the terminal of the flat cable 13 in the above-described embodiment, it is possible to minimize a wasteful portion of the flat cable 13 which is located on the distal end side of the portion clamped by the holding member 12 and which does not function, and it is possible to gain the creeping distance efficiently.

As described above, according to the structure for processing a terminal of a flat cable in accordance with the invention, since the creeping distance between the cut surfaces of adjacent ones of the conductors becomes long by cutting the end portion of the flat cable in a stepped form such that the cut surfaces of the conductors are positioned in different planes, it becomes difficult for a leakage current to flow between the conductors.

Accordingly, it becomes unnecessary to cover the cut surfaces of the conductors by, for example, coating the end face of the flat cable with an insulating resin or covering the end portion thereof with an insulating cap, thereby making it possible to prevent the cost from rising due to the increase in the number of steps of operation and the number of component parts.

Hence, it is possible to provide an inexpensive structure for processing a terminal of a flat cable in which a plurality of juxtaposed conductors are insulated and coated and which makes it possible to prevent the occurrence of a leakage current between the conductors at an end portion of the flat cable.

What is claimed is:

1. A structure for processing an end portion of a flat cable in which a plurality of juxtaposed conductors are sheathed and insulated, respectively, wherein the end portion of the flat cable is cut in a stepped form so that cut surfaces of at least adjacent ones of the conductors are positioned in different planes.

2. The structure according to claim 1, wherein the end portion of the flat cable is cut in the stepped form so that the cut surfaces of the conductors are alternately positioned in a staggered manner.

3. A method of processing an end portion of a flat cable in which a plurality of juxtaposed conductors are sheathed and insulated, respectively, the method comprising the step of:
cutting the end portion of the flat cable in a stepped form so that cut surfaces of at least adjacent ones of the conductors are positioned in different planes.

4. The method according to claim 3, wherein the end portion of the flat cable is cut in the stepped form so that the cut surfaces of the conductors are alternately positioned in a staggered manner.

5. The method according to claim 4, wherein the flat cable is collectively cut along a widthwise direction of the flat cable by using a cutter blade having a blade shape in which rectangular sections continue in a zigzag manner.
